(19) United States
(12) Patent Application Publication
(10) Pub. No.: US 2005/0287282 A1
(43) Pub. Date: Dec. 29, 2005

(54) Cereal-Based Adhesives and Their Uses

(75) Inventor: Zhongli Pan, Davis, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California, Oakland, CA (US)

(21) Appl. No.: 10/881,096

(22) Filed: Jun. 29, 2004

(51) Int. Cl. A21D 2/00

(52) U.S. Cl. 426/618

(57) ABSTRACT

This invention provides methods of preparing a cereal-based adhesives. The methods comprise adjusting the pH of a cereal bran slurry to a pH of at least about 8 and heating the cereal bran slurry to at least about 80° C. The cereal bran slurry typically comprises about 20% solids and can be ground to a desired particle size. The method may further comprise drying the slurry to produce a dry powder, which can be reconstituted to produce an adhesive of the invention.

### BACKGROUND OF THE INVENTION

Rice bran, a byproduct of the rice milling industry, has been the focus of attention of many researchers who, in the last decades, have attempted to extract and take advantage of its valuable components. It is obtained by abrasive milling of brown rice which removes the outer maternal tissues to produce the widely consumed milled and polished rice (Juliano, B. O. Polysaccharides, Proteins, and Lipids of Rice. In Rice: Chemistry and Technology. B. O. Juliano, ed. The American Association of Cereal Chemists, Inc. St. Paul, Minn. (1972)). Total U.S rice production for 2002/03 was projected at a record 9.6 million tons (USDA. Rice Situation and Outlook Yearbook November 2002. USDA Economic Research Service. Washington, D.C. (2002)). Because rice bran constitutes approximately 10% of the weight of rough rice, there is a potential to produce almost one million tons of this byproduct which has been mostly utilized as an animal feed ingredient, fertilizer and fuel (Bera, M. B. Use of Deoiled Rice Bran: Present Status and Future Possibilities. Indian Food Industry 11(3):36-38 (1992) Shi, F. F. et al. Nahrung 43(1):14-18 (1999); Juliano, B. O. Rice Bran. In Rice: Chemistry and Technology. B. O. Juliano, ed. The American Association of Cereal Chemists, Inc. St. Paul, Minn. (1985)).

An increasing demand for environmentally friendly adhesives, together with the uncertainty of the variable and volatile petrochemical market, has promoted the development of adhesives from renewable and inexpensive sources (Kalapathy U. et al JAOCS 72(5):507-510 (1995)). In most cases, the adhesive potential of these renewable products relies on the binding capability developed by some of their fundamental constituents (primarily protein and carbohydrates) when subjected to the appropriate conditions. In fact, protein and starch have been recognized for centuries for their important adhesive properties.

A typical composition of defatted rice bran found in the United States is 15-20% protein, 0.5-1.5% fat, 10-15% crude fiber and 9-12% ash. Rice bran also contains a significant amount of starch, depending on the amount of breakage and degree of milling, which can vary from 10-20% (Hargrove, K. L. Processing and Utilization of Rice Bran in the United States. In Rice Science and Technology. W. E. Marshall and J. I. Wadsworth, eds. Marcel Ekker, Inc. New York, N.Y. (1994)).

Alexander, R. J. et al. U.S. Pat. No. 4,070,314 (1978) found that rice bran and other high fiber amylose-containing byproducts from the grain milling and processing industries can function as extenders for plywood glue systems. Commercially, there are adhesive extenders such as one marketed as Glu-X which is a starch adhesive extender for wood panels (plywood) milled from wheat.

Although formaldehyde-containing resins are widely used as adhesives in the manufacture of lignocelulosic materials, such as particleboard, alternative adhesive systems are of interest, due to the highly toxic nature of formaldehyde (Peng W., G. F et al. Particleboard Made with Starch Based Adhesives. TEKTRAN. United States Department of Agriculture. Agricultural Research Service (1997)). The most common formaldehyde adhesives are Urea-Formaldehyde (UF), Phenol-Formaldehyde (PF) and Melamine-Formaldehyde (MF). Relatively new synthetic adhesives for panel products are the diisocyanates (Dix, B. et al. Modification of Diisocyanate-Based Particleboard and Plywood Glues with Natural Polymers Polyphenols, Carbohydrates, and Proteins. In Adhesives from Renewable Resources. R. W. Hemingway and A. H. Conner, eds. American Chemical Society, Washington, D.C. (1989)). Advantages of the diisocyanates include their high reactivity, high binding quality for exterior-grade panel products, and no formaldehyde emission potential. Disadvantages of diisocyanates, however, include their higher price and the higher toxicity of the uncured glue in comparison with other adhesives.

Soy protein has also been used in the production of particleboard (Lambuth, A. L. Blood Glues. In Handbook of Adhesives. I. Skeist, ed. Van Nostrand Reinhold Company. New York, N.Y. (1977)). All three sources of soy protein: flour, concentrate and isolate may be used in adhesive formulations. However, due to their low water resistance and reported relatively low adhesive strength, soy-protein-based adhesives, have not yet performed very well in the marketplace (Myers, D. Potential of Modified Soy Isolate as Particle Board Adhesive. Center for Crop Utilization Research. Iowa State University (1994)).

Mo, X., E et al. Industrial Crops and products. 18:47-53 (2003) studied the properties of wheat straw particleboard bonded with soy flour or soy protein isolate and found that the soybean-based adhesive showed similar or better mechanical strength than UF resins for particleboard made from bleached straw. Attempts have also been made to use starch-based adhesives in particleboard systems. Weiling, P., G. et al. Particleboard Made with Starch Based Adhesives. Tektran. United States Department of Agriculture. Agricultural Research Service (1998) found that in the presence of additives, the properties of particleboard prepared with jet-cooked starch-based adhesives approached those obtained with formaldehyde-containing resins.

Despite a number of efforts to use soy and starch-based adhesives for the production of particle panels, this practice has not yet found real commercial applicability. In the mean time, research continues to focus on reducing environmental and health hazards by attempting to replace a portion or all of synthetic adhesives with more environmentally friendly alternatives to obtain satisfactory products. This invention addresses these and other needs.

### BRIEF SUMMARY OF THE INVENTION

This invention provides methods of preparing a cereal-based adhesives. The methods comprise adjusting the pH of a cereal bran slurry ( e.g., rice bran) to a pH of at least about 8 (usually between about 8 and about 12) and heating the cereal bran slurry to at least about 80° C. The cereal bran slurry typically comprises about 20% solids and can be ground to a desired particle size. The method may further comprise drying the slurry to produce a dry powder, which can be reconstituted to produce an adhesive of the invention. The invention also provide cereal based adhesives made by the methods of the invention. The adhesives of the invention can be used to join two substrates together in a variety of uses. For example, substrates may comprise lignocellulosic material and be used to prepare particle board or fiber board.

### DEFINITIONS

The term “bio-based adhesives” refers to substances that are able to join materials together in their natural state (as found in nature) or those that incorporate an environmentally friendly constituent as the main binder.

The term “composite panel” is used here to refer to panels primarily composed of lignocellulosic materials, generally in the form of discrete particles (in the case of particleboard) or fibers (in the case of fiberboard) bonded together with a bonding system, and that may contain additives. The main lignocellulosic raw material used in the particleboard and fiberboard is wood, but other agro-based residues can also be used. For example, annual plant wastes such as flax and hemp shives, jute stalks, bagasse, reed stalks, cotton stalks, grass-like miscanthus, vetiver roots, rape straw, oil flax straw, small grain straw such as rice straw, peanut husks, rice husks, grape-vine stalks and palm stalks are inexpensive and valuable raw materials for lignocellulosic board production (American Society of Testing and Materials. Standard Terminology Relating to Wood-Base Fiber and Particle Panel Materials. Designation: D 1554-01. West Conshohocken, Pa. (2001); Kozlowski, R. et al., Bast Fibrous Plants as a Source of Raw Materials for Diversified Areas of Application (2003)).

As used here, an “adhesive” is a material capable of joining materials together by means of surface attachment. Adhesives include cement, glue, paste, and the like. This property is not necessarily an intrinsic characteristic of the substance itself since the adhesive may be much weaker than the materials joined together until strength is developed as the adhesive interacts with the adherends under appropriate conditions. Examples of applications that make use of this advantage unique to adhesives include particleboard, laminates of films of cellophane, paper, sandpaper, glass fiber, paper bags, labels, tapes, stamps and safety glass. Adhesives are also advantageous because stresses are distributed over wider areas, making possible lighter and stronger assemblies than could be achieved with mechanical fastening.

### BRIEF DESCRIPTION OF THE DRAWINGS

FIG. 1 shows the structure of a rice grain (from Juliano, B. O. et al. The Rice Grain and Its Gross Composition. In Rice: Chemistry and Technology. B. O. Juliano, ed. The American Association of Cereal Chemists, Inc. St. Paul, Minn. (1972)).

FIG. 2 shows a specimen preparation for adhesive strength determination test. (a). Glue is applied on each side of the wood piece B. (b). Two wood pieces, A₁ and A₂, are placed on glued areas and pressed.

FIG. 3 shows tension loading to determine adhesive strength.

FIG. 4 shows the effect of pH and temperature on rice bran adhesive yield. Bands in results figures represent standard deviation.

FIG. 5 shows the effect of pH and temperature on rice bran adhesive strength.

FIG. 6 shows the effect of pH and temperature on rice bran adhesive viscosity measured at 100 rpm.

FIG. 7 shows the effect of pH and temperature on rice bran adhesive viscosity measured at 200 rpm.

FIG. 8 shows the effect of pH and temperature on the pH of rice bran adhesive.

FIG. 9 shows particleboard tensile strength measured for particleboard as a function of percent PMDI removal and replacement with rice bran adhesive.

FIG. 10 shows particleboard modulus of rupture as a function of percentage PMDI removal and replacement with rice bran adhesive.

FIG. 11 shows particleboard modulus of elasticity as a function of percentage PMDI removal and replacement with rice bran adhesive.

FIG. 12 shows particleboard internal bond strength as a function of percentage PMDI removal and replacement with rice bran adhesive.

FIG. 13 shows particleboard short term water absorption as a function of percentage PMDI removal and replacement with rice bran adhesive.

FIG. 14 shows particleboard long term water absorption as a function of percentage PMDI removal and replacement with rice bran adhesive.

FIG. 15 shows short term particleboard thickness swell as a function of percentage PMDI removal and replacement with rice bran adhesive.

FIG. 16 shows long term particleboard thickness swell as a function of percentage PMDI removal and replacement with rice bran adhesive.

### DETAILED DESCRIPTION

Cereal Bran Composition

Bran from any cereal species can be used in the methods of the invention. Generally, bran is used to refer to the coarse, chaffy part of ground grain such as corn, wheat, rye, rice or other cereal grain. It is typically separated from the flour or meal by sifting or bolting. The following description describes the production and composition of rice bran in detail. One of skill will recognize that other cereal brans can be prepared by similar and well known methods.

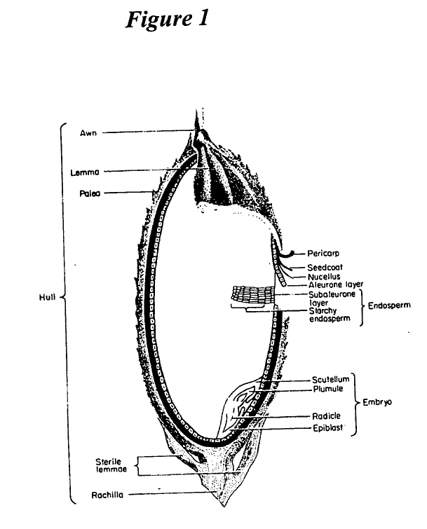

Dehulling separates the hull from the brown rice (rice caryopsis) while abrasive milling removes the outer maternal tissues, producing milled rice and the by-products bran and polish. Though in general these two byproducts together are referred to as simply “bran” the actual bran contains more of the pericarp, seed coat (tegmen), nucellus, aleurone layer, and germ than the polish (“white bran”), which contains relatively more of the starchy endosperm (See FIG. 1). Weed seeds, straw, hulls, dust, and calcium carbonate (milling aid) may also be present in varying amounts in commercial rice bran. Bran removal usually amounts to approximately 10% of the weight of rough rice.

In most US mills, rice hulls are removed in a process that is separate from the actual milling process. In this case, during hulling, what is known as sheller bran is produced. It is of course made up fundamentally of hull fragments, but it may also include a small portion of pericarp, some germ and rachilla and small fragments of endosperm, as well as dust and soil. However, due to its small production and low feeding value, huller bran is a byproduct of little importance.

In the process of whitening, rice bran is abrasively removed from brown rice. As mentioned earlier this bran is made up of fragments of the pericarp, the tegmen, nucellus and the aleurone layer, together with the germ. Some starchy endosperm, fragments of the caryopsis and occasionally due to defective processing, some particles of hull are also present. Although the words whitening and polishing are alternatively used, the latter involves the removal of any fine particle adhering to the grain so that the kernel acquires the familiar glossy appearance.

In general, the composition of rice bran depends on a variety of factors associated with the rice grain itself and the milling process. The major factors associated with the rice grain are variety and environmental variability while those associated with the milling process are the processing methods and machines, and milling conditions as they affect the degree and uniformity of milling. For such reasons, data published on the composition of bran vary within a wide range (Table 1). Because of variations in bran composition, eventually resulting in commercial bran adulteration, it is a market practice to guarantee a limit composition.

Table 1. Usual range of variation of the gross chemical composition of rice bran (from Barber, S. et al. Rice Bran: Chemistry and Technology. In Rice: Production and Utilization. L. Bor, ed. Avi Publishing Company, Inc. Westport, Conn. (1980) and Benedito, 1980).

| Constituent | | Maximum |
|---|---|---|
| Protein | 6.7³; 11.5 | 17.2 |
| Fat | 4.7³; 12.8 | 22.6 |
| Fiber | 6.2 | 14.4; 26.9³ |
| Ash | 8.0 | 17.7; 22.2³ |
| NFE² | 33.5 | 53.5 |

¹Includes data from: India (Panda and Gupte 1965), Italy (Fossati et al. 1976; Leonzio 1965; Maymone et al. 1962), Japan (Yokochi 1977), Malaysia (Arnott and Lim 1966), Mexico (Yokochi 1977), Nepal (Yokochi 1977), Philippines (Limcangco-Lopez et al. 1962), Spain (Primo et al. 1970), Sri Lanka (Siriwardene 1969) and the United States (Betschart et al. 1977; Lew et al. 1975).
²Nitrogen-free extract.
³For huller type mills.

As compared to other cereal brans, rice bran has higher fat content but comparable protein and fiber content. It has higher ash content than most cereal brans except that of millet and is richer in silica compared to other brans. The proximate composition of stabilized, parboiled, and defatted rice bran is shown in Table 2. Defatting of rice bran can be carried out according to methods well known in the art.

TABLE 2
Approximate composition of stabilized, parboiled and defatted
rice bran (from Hargrove, K. L. Processing and Utilization of Rice
Bran in the United States. In Rice Science and Technology. W. E.
Marshall and J. I. Wadsworth, eds. Marcel Ekker, Inc. New York,
NY (1994)).

| | | | | Crude | | |
|---|---|---|---|---|---|---|
| | Moisture | Protein | Fat | fiber | Ash | Calories/ |
| | (%) | (%) | (%) | (%) | (%) | oz. |
| Rice bran | 8-12 | 12-16 | 17-22 | 8-12 | 7-10 | 90-100 |
| Parboiled rice bran | 7-9 | 17-20 | 25-32 | 12-15 | 8-10 | 100 |
| (without calcium | | | | | | |
| carbonate) | | | | | | |
| Parboiled rice bran | 6-9 | 14-18 | 23-27 | 10-13 | 10-13 | 100 |
| (with calcium | | | | | | |
| carbonate: 4-6%) | | | | | | |
| Defatted bran | 6-9 | 15-20 | 0.5-1.5 | 10-15 | 9-12 | 60 |
| Defatted parboiled bran | 6-9 | 23-27 | 0.5-1.5 | 16-20 | 11-14 | 40 |
| (without calcium | | | | | | |
| carbonate) | | | | | | |

The protein contents of bran (including germ) and polish of high and low protein rice varieties are as follows: bran, 13.3-15.5% and 16.0-17.4%; and polish, 12.2-14.1% and 17.9-19%. The major protein fractions in bran are the water soluble albumin and salt soluble globulin. Alkali soluble glutelin is the major protein in polish due to the presence of rice endosperm. Alcohol soluble prolamin is the minor fraction in both cases.

The major carbohydrates present in commercial rice bran are starch, cellulose, and hemicelluloses (or pentosans). Starch is not botanically present in the outer pericarp layers of rice but a significant amount of starch is present in commercial bran due to endosperm breakage during milling. Starch content ranges from about 10-55% (dry basis) and depends on the amount of rice breakage and degree of milling. Values of 10-20% are common. Free sugars are apparently absent in pericarp, tegmen and aleurone layers. Nevertheless, reported values for total sugar content of rice bran range from about 3-5% (dry basis) presumably due to the contribution of germ and endosperm. Nonreducing sugars are more abundant than reducing sugars and among the free sugars reported to be present in rice bran are glucose, fructose, and sucrose.

Cellulose in rice bran is reported to range from 9.6-12.8%, while hemicelluloses from 8.7-11.4%. Beta-glucans in rice bran are present at less than 1%. These polysaccharides comprise part of the dietary fiber complex (Hargrove, K. L. Processing and Utilization of Rice Bran in the United States. In Rice Science and Technology. W. E. Marshall and J. I. Wadsworth, eds. Marcel Ekker, Inc. New York, N.Y. (1994)).

In addition to starch and protein, rice bran also contains minerals and vitamins among other minor components. These elements are present in rice bran in amounts that depend on the rice variety, soil conditions, growing environment, and milling process used. Lignin may be present in bran in amounts ranging from 7.70-13.11%. Lignin, cellulose and hemicelluloses may grant some adhesive properties to rice bran under the appropriate conditions. However, due to their relatively high content and their recognized adhesive capability, starch and protein are the critical components responsible for rice bran's adhesive potential.

Bio-Based Adhesives

Bio-based adhesives have been developed and extracted from a variety of animal and vegetable sources for use in a number of applications. In general, they are based on organic polymers such as high molecular weight polysaccharides and proteins. A polymer is a compound formed by the reaction of simple molecules having functional groups that permit their combination to proceed to higher molecular weights under suitable conditions Adhesives of vegetable origin are probably the first adhesives used by humans. They owe their binding properties to a wide range of components such as starch and protein which are the base for the most common bio-based adhesives. Other elements including tannins, lignin and a number of other carbohydrates may also yield satisfactory adhesives. Adhesives of animal origin have been mainly obtained from byproducts of the meat and dairy industries and include but are not limited to bones, blood, hides, whey from the cheese manufacturing industry and casein. Most adhesives from animal sources owe their bonding properties mainly to protein. Bio-based adhesives of either animal or vegetable origin represent an option to many industries that have been searching for alternative uses for their production byproducts.

The adhesive properties of natural compounds may be inherent or may be developed by means of physical or chemical treatments. Heat and high pH can be conveniently used to modify carbohydrates and proteins to obtain useful adhesives.

The adhesive strength of a protein depends on its ability to disperse in water and on the interactions of non-polar and polar groups of the protein with the substrate. In a native protein, the majority of these groups are unavailable due to internal bonds resulting from van der waals forces, hydrogen bonds, and hydrophobic interactions. A chemical change is required to break the internal bonds and uncoil or “disperse” protein molecules. Dispersions and unfolding of a protein are enhanced by hydrolysis or by increasing the pH which can be accomplished by exposure to heat, acid/alkali, organic solvents, detergents and urea. Guanidine hydrochloride can be used to denature soy proteins and obtain an adhesive suitable for use in fiberboard (Zhong, Z. et al. Adhesive strength of guanidine hydrochloride-modified soy protein for fiberboard application. International Journal of Adhesion & Adhesives. 22: 267-272 (2002)). Soy protein can also be modified with sodium hydroxide, urea, and dodecylbenzene sulfonic acid (Mo, X., J. Hu et al. Industrial Crops and Products. 14:1-9 (2001)). Commercial soybean protein fractions can also be hydrolyzed with acid and alkaline catalysts to provide a mixture of oligomeric polypeptides and amino acids with viscosity and reactivity properties suitable for incorporation into phenolic wood adhesive systems (Kriebich, R. E. New Adhesives Based on Soybean Proteins. American Soybean Association, Weyerhaeuser Technology Center. Tacoma, Wash. (2001)).

Sulfites may also contribute to protein unfolding (therefore to adhesion) by cleaving inter- and intra-disulfide bonds exposing molecules that can contribute significantly to the binding capabilities of the protein. Kalapathy U. et al. JAOCS 73(8):1063-1066 (1996) treated soy protein isolates with sodium sulfite to observe the effects of these salts on viscosity, adhesive strength and water resistance of a soy based adhesive for wood. Though the authors were able to obtain an adhesive with satisfactory strength and viscosity at low levels of sulfites, reduced adhesive strength was observed at high levels of sulfites addition.

Protein solubility is also important to obtain a homogeneous and satisfactory adhesive. Proteins from natural sources have been solubilized by a wide variety of methods which also include pH manipulation and hydrolysis. Protein hydrolysis by means of sulfites and more recently enzymes has been a widely used method to hydrolyze proteins to improve their solubility. Specifically, increasing the pH of a rice bran slurry with alkali has been the most common approach used to solubilize rice bran proteins.

For starch gelatinization is the single most important requirement to develop its adhesive characteristics. Ungelatinized starch is incapable of adhering to any substrate because the molecules within the unpasted granules are already tightly bonded to one another. In order for starch molecules to become detached from each other, they must be hydrated, a process accomplished in a water slurry by using either thermal or chemical energy. Only then the molecules will be separated and uncoiled enough to be able to latch onto other particles and exert adhesive properties. As a starch solution is exposed to a high temperature, a dramatic increase in viscosity becomes obvious as the swelling granules soak up large amounts of water until they begin to rupture, so molecules can leach out of the granule fragments to react with substrate molecules. Gelatinization of starch can also be accomplished by chemical means. The most common form of chemical hydration is the use of alkali. Gelatinization occurs when the adsorbed alkali in starch exceeds a certain critical level, which depends on the species of starch and the type of alkali.

Methods of Preparing Bio-Based Adhesives

Cereal brans (e.g., rice bran) can be prepared according to well known techniques as generally described above. Alternatively, they may be was obtained from commercial suppliers such as RITO, Inc. (Stuttgart, Ariz.).

As noted above, high temperature and pH conditions are used to bring about the adhesive properties of rice bran. Prior to preparation of the adhesive, the cereal bran can be conveniently milled to a desired particle size. Mills useful for such purposes are well known in the art. Typically, milling results in particle sizes that pass through a US #100 mesh. The cereal bran is used to prepare a slurry with water, preferably deionized water. The slurry is typically made to be about 10% to about 40% cereal bran, usually about 15% to about 30%, and most often about 20%. The pH of the resulting slurry can be adjusted using any strong base, usually IN NaOH solution. The pH can be adjusted to a pH between about 8 and 12. Usually about 12.

The pH-adjusted slurry is then heated according to well know techniques to at least about 80° C., usually up to 100° C. or 120° C. Such temperatures can conveniently be achieved in water bath shaker a sterilizer. In some embodiments, the final slurry can dried to a moisture content of approximately 10% (e.g., oven dried at 75° C. for at least 24 hours). The resulting dried powder can then be reconstituted in water to prepare adhesives of the invention.

Adhesive Testing

The chemical, physical, and other characteristics of adhesives can be used to predict the performance and reliability of an adhesive bond. There are a number of test methods in the literature for measuring the physical and other adhesive characteristics. In general, these methods utilize specimens of standard dimension, shape, and design prepared specifically for the purpose.

Adhesives of the invention can also be evaluated using a specimen assembly that most closely resembles the particular service application of the adhesive. Adhesive performance is also dependent on the substrate and therefore, the substrate material should be the same or similar to the material to be bonded during service.

The accuracy and reproducibility of test results normally depend on the test conditions. Surface considerations are very important when characterizing adhesive performance. To achieve reproducible test results the surfaces of the adherends are preferably consistent among test replicates. Substrate surfaces should be prepared according to standard procedures or to suit specific applications. Using clean and dry surface specimens with controlled moisture content can minimize experimental errors that may result from surface variability. Complete instructions for adhesive mixing (if pertinent) together with conditions for application (rate of spreading, thickness of film, drying conditions) and assembly (temperature, relative humidity) should also be specified. Furthermore curing conditions, including the pressure and time/temperature pressing conditions, are also important parameters.

A number of test methods have been developed and proposed by government, industrial and academic entities for predicting adhesive performance. The American Society of Testing and Materials (ASTM) publishes the most accepted and generalized testing procedures. Adhesive strength and stability are typically the most desirable adhesive characteristics.

The strength of the adhesive is usually determined by measuring the force required to break an adhesive bond. The most common parameters measured to estimate adhesive strength are tensile and shear strengths. Peel, creep, impact, fatigue and flexural loading tests are some of the many tests that can be performed to test adhesives. As mentioned earlier, the specific tests for certain applications perform should be selected depending on the type of information an experimenter wants to obtain.

An adhesive is in tensile loading when the acting forces are applied perpendicularly to the plane of the adhesive bond. The tensile strength of an adhesive bond is the maximum tensile load per unit area required to break this bond. Shear stresses, on the other hand, are those forces which act in the plane of the adhesive layer and reflect the total stress exerted by the adherends along the adhesive plane which tend to slide the adherends in opposite directions. American Society of Testing and Materials. Standard Test Method for Strength Properties of Adhesive Bonds in Shear by Tension Loading. Designation: D 906-94a. West Conshohocken, Pa. (1994) describes the standard test method for strength properties of adhesives in plywood type construction in shear by tension loading. In contrast, Method D 905-94 (American Society of Testing and Materials. Standard Test Method for Strength Properties of Adhesive Bonds in Shear by Tension Loading. Designation: D 906-94a. West Conshohocken, Pa. (1994)) describes the standard test method for determining the strength properties of adhesive bonds in shear by compression loading.

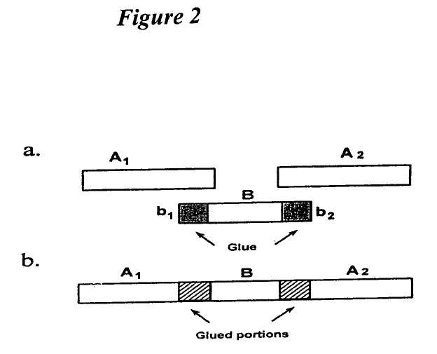

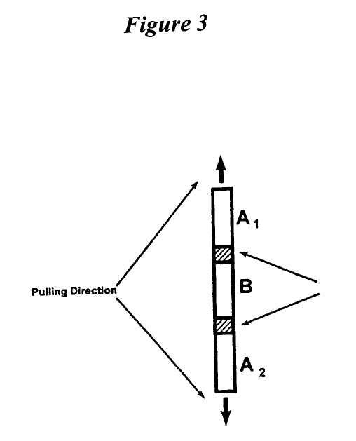

Besides the ASTM standard methods, a number of adhesive testing methods for a wide range of applications have been published. These tests are, in general, modifications of the ASTM standard procedures and are widely used and accepted among researchers and scientists. Kalapathy U. et al JAOCS 72(5):507-510 (1995) proposed a method to test the adhesive strength of a soy protein isolate-based adhesive. This testing method which is illustrated in FIGS. 2 and 3 requires wood specimens of rectangular shape.

Particleboard Quality Assessment

ASTM also publishes standard procedures to evaluate the properties of particleboard. Method 1037-99, “Standard Test Methods for Evaluating Properties of Wood-Base Fiber and Particle Panel Materials” describes several tests to assess the quality of particleboard. The tests to perform depend on the end use that will be given to the final particleboard product. For example, water resistance tests are important if the end product is intended for use under extreme conditions of relative humidity. Furthermore, “the choice between a particular test method and its alternative should be made with a full understanding of the intended purpose of each, because values obtained from tests may, in some cases, ddiffer” (American Society of Testing and Materials. Standard Test Methods for Evaluating Properties of Wood-Base Fiber and Particle Panel Materials. Designation: D 1037-99. West Conshohocken, Pa. (1999)).

Because the physical and mechanical properties of building boards depend on the moisture content at time of test, the material to be tested shall be conditioned to constant weight and moisture content in a conditioning chamber at a relative humidity of 65±1% and a temperature of 20±3° C. If different conditions are used, it shall be so stated in any report. American Society of Testing and Materials. Standard Test Methods for Evaluating Properties of Wood-Base Fiber and Particle Panel Materials. Designation: D 1037-96a. West Conshohocken, Pa. (1996) also specifies the requirement for reporting the size of the finished board, thickness, and density which are very important parameters that must be specified when characterizing particleboard properties. The following tests were performed in this research study to determine the properties of particleboard: tensile strength, static bending, internal bond and water absorption and thickness swell.

Tensile strength tests are performed to determine cohesion of the particleboard in the direction perpendicular to the plane of the board. The test is performed by gripping the two ends of a piece of board and applying a constant tensile load in the direction parallel to the surface of the board until the board sample finally breaks. The speed of testing is also an important factor that affects the tensile strength of the board and therefore should not only be kept constant for all readings within an experiment but it should also be specified along with any results.

The three point bending test is also frequently performed to determine particleboard quality. This test not only provides information on the flexural properties of the particleboard but also allows calculation of modulus of elasticity (MOE) and modulus of rupture (MOR). The modulus of elasticity is a measure of stiffness and indicates the ability of the board to resist deflection. The modulus of rupture, on the other hand, measures the maximum bending load that the board can support. To perform this test, force is applied at three different places along the rectangular specimen which is set over two static supports at the ends while a third force is gradually applied in compression at the center, bending the board until it finally breaks. The length of the span and geometry of supports and loading block are important factors in this test. Speed of testing and board dimensions are also important as in all mechanical tests where a constant velocity load is gradually applied.

The internal bond test is also very important for assessing particleboard performance because it is a measure of the cohesiveness and strength of the board. This test is described in American Society of Testing and Materials. Standard Test Methods for Evaluating Properties of Wood-Base Fiber and Particle Panel Materials. Designation: D 1037-96a. West Conshohocken, Pa. (1996) as “tensile strength perpendicular to surface”. This test is similar to the tensile strength test but the tensile load is applied in the direction perpendicular to the surface of the board. Therefore, the same considerations as before in terms of moisture content and speed of testing shall be taken into account. To perform this test both particleboard specimen surfaces are glued to two pieces of metal. The joined assembly is then attached to the Instron machine for testing. The challenge inherent to this test is to find an adhesive that is stronger than the board itself and to clean the adhesive after each test effectively and in a relatively short time. In general, all tests should be performed in both dry and soaked states if the material is to be used under severe conditions.

Water absorption and thickness swell tests are important for assessing the performance of the particleboard under the influence of liquid water, which provides information on how well the board may perform in severe weather conditions. This test is also clearly described in American Society of Testing and Materials. Standard Test Methods for Evaluating Properties of Wood-Base Fiber and Particle Panel Materials. Designation: D 1037-96a. West Conshohocken, Pa. (1996) and consists of immersing the board specimen with specified dimensions under one inch of liquid water and measuring the percentage of water absorption and thickness swell after a given amount of time.

### EXAMPLES

The following examples are offered to illustrate, but not to limit the claimed invention.

### Example 1

Adhesive Performance of Rice Bran as a Function of Thermal and Chemical Treatments

Preliminary studies in the laboratory showed that the adhesive properties of rice bran improved under moderately high temperature and high PH conditions. These results prompted a more detailed investigation to determine the optimum conditions required to obtain a rice bran-based adhesive.

### Materials and Methods

Rice Bran Modification

Defatted rice bran was obtained from RITO, Inc. (Stuttgart, Ariz.) and contained 3.8% fat, 16.6% protein and 11.3% ash according to manufacturer specifications. Wood pieces (soft maple with dimensions 5×2×0.3 cm) were purchased from White River Hardwoods, Woodworks, Inc. (Fayetteville, Ariz.). Wood pieces were conditioned to constant moisture content in a Fisherbrand® Desiccator Cabinet maintained at a relative humidity of 58% by means of a saturated NaBr solution and a temperature of approximately 25° C.

High temperature and pH conditions were used to bring about the adhesive properties of rice bran. Enough rice bran for all treatments was milled in a Stein Laboratory Mill (Model M2; The Steinlite Co., Atchison, Kans.) for 3 minutes and stored at 5° C. prior to the thermal and chemical treatments. Milling resulted in 45% of rice bran passing through a US #100 mesh compared to only 10% for the original bran. A 20% milled rice bran (RB) solution was prepared in a beaker with deionized water. The pH of the resulting slurry was adjusted to 8, 10 or 12 with a 1N NaOH solution. The slurry was then heated in a water bath shaker (Model R76; New Brunswick Scientific Co., Inc. Edison, N.J.) to 80° C. or in a sterilizer (Model SR-24C; Consolidated Stills & Sterilizers, Boston, Mass.) to 100 or 120° C. To determine the effect of sulfites on the adhesive properties of rice bran, a 20% RB solution was prepared and adjusted to 0.5 and 1 M sodium sulfite or sodium bisulfite. The slurry was further adjusted to pH 12 and then heated to 100° C. as mentioned above. All treated slurries were oven dried in metal trays at 75° C. for at least 24 hours to a moisture content of approximately 10%.

Measurement of Adhesive Yield, Strength, Viscosity and PH

The dried RB was milled for 3 minutes and sieved through a US #100 mesh. This sieved portion containing particles smaller than the 0.15 mm nominal sieve opening was further referred to as the rice bran adhesive (RBA). The adhesive yield was determined with the following equation:

$$Yield = \frac{{A}_{( t )} - {A}_{( r )}}{{A}_{( t )}} \times 100 \% \qquad ( 1 )$$

Where A(t) is the total amount of oven dried RB, and A(r) is the amount retained by the 100 mesh sieve. Yield, as calculated, is not only a relative measure of the amount of RBA obtained per amount of RB but is also a measure of the hardness of the oven dried rice bran product. The harder the product, the less likely it will break enough during milling to pass through the sieve openings. Therefore, a harder and more cohesive dried product will result in a lower RBA yield. As a result, a low yield value for a given sample may reflect strong adhesive properties.

A 10% RBA solids dispersion was prepared and stirred for 1 hour to attain proper hydration before the sample was used for viscosity, pH or strength measurements. PH and viscosity of the prepared adhesive were determined using a pH meter (Accumet® AR 20; Fisher Scientific) and Brookfield viscometer (Model RVT 200; Brookfield Engineering Laboratories, Inc., Stoughton, Mass.) with a #3 spindle. Viscosity was measured at 100 and 200 rpm immediately after vigorous stirring.

Viscosity is an important adhesive property. In general, an adhesive must have a relatively low viscosity in order to be easily handled and applied. Measuring adhesive pH, on the other hand, is important because it may determine the stability of the final particleboard product. RBA pH was also measured to examine how this value compared to the pH of the RB solution prior to heat and other modification treatments.

The strength of RBA was determined according to the method proposed by Kalapathy U. et al JAOCS 72(5):507-510 (1995). 0.1 g of the prepared RBA was placed on each side of a wood piece (5×2×0.3 cm) and spread on the marked areas (2×2 cm²). Refer to FIGS. 3.2 and 3.3. Two other wood pieces were superimposed on the glued portions and pressed with a load of 5 Kg for 2 hours. The load was then removed and the glued wood pieces were allowed to dry for 24 hours in the desiccating cabinet at the same temperature and relative humidity conditions used for wood conditioning. The force in newtons required to shear the adhesive bond between wood pieces was measured on an Instron testing machine (Model 1122; Instron Corporation, Canton, Mass.) using a crosshead speed of 0.5 mm/min. This measured force was defined as adhesive strength.

Experiment Design and Data Analysis

Experiments were conducted according to a split-plot design to determine if the effects of temperature (main factor) and pH (sub-factor) on the properties of RBA were statistically significant both individually and through their interaction. The tests were repeated in three time blocks. The values recorded for adhesive strength in each time block are the average of five repeated observations. Statistical analyses, including ANOVA and Tukey's Studentized Range Tests (at 95% confidence level), were performed by means of SAS software (SAS Institute, Raleigh, N.C.). The reported results of the effect of sulfites on the properties of RBA correspond to the average of 5 observations.

### Results and Discussion

Adhesive Yield

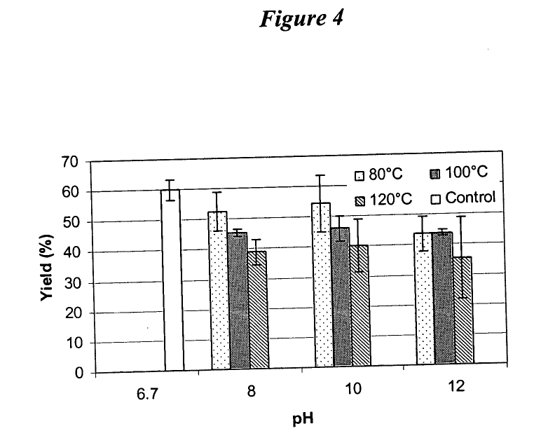

In general, as depicted in FIG. 4, RBA yield decreased with the increase of treatment temperature and pH. Yield decreased from approximately 60% for the control to 35% for the sample treated at pH 12 and 120° C. The RBA control is a sample that was not subjected to pH or temperature treatments but was prepared similarly to the treated samples (i.e. It was made by preparing a 20% RB solution, was oven dried, milled and sieved).

As mentioned earlier, low adhesive yield may indicate high binding capability. As treatment temperature increased from 80 to 120° C., improved adhesive cohesion was evident during oven drying. While the dried 80° C. samples appeared more brittle inside the drying tray and showed many cracks on the surface, the dried 100 and 120° C. samples were much harder and had very smooth surfaces. Also, the samples treated at higher temperatures dried in a less uniform manner such that the outer part of the adhesive that was in contact with the oven air dried first, forming a compact layer that obstructed water evaporation from the inside. In many cases, this resulted in an oven dried product with an uneven moisture distribution where moistened particles tended to attach to one another contributing further to the reduced yield. Increasing the pH above 10 may result in increased protein unfolding which may also contribute to improve RBA cohesion by exposing potentially binding molecules that were previously buried inside the coiled protein.

Statistically, Tukey's test showed that pH 8 treatment was not different from pH 10 or 12 treatments, however the latter treatments were significantly different from each other. In contrast to pH alone, temperature and pH-temperature interaction had no statistically significant effect on RBA yield. Although, based on the split plot design, the results showed that temperature was not significant, by looking at the means and standard deviation bars at pH 8 (FIG. 4) it appears that yield decreased as the temperature increased. This would imply that better adhesive capabilities were obtained as temperature increased from 80 to 120° C.

Adhesive Strength

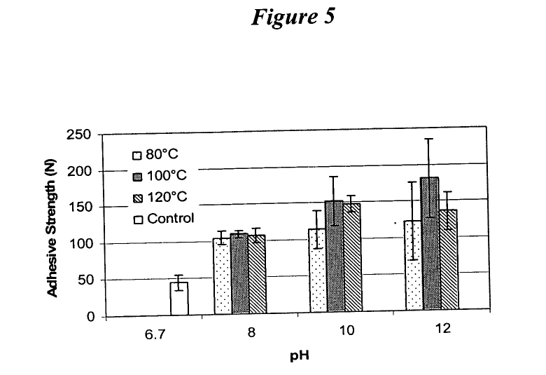

The effect of pH and temperature on the strength of RBA is shown in FIG. 5. PH and temperature treatments significantly improved the adhesive performance of RBA compared to the control. Adhesive strength increased from 44N for the control to 181N for the sample treated at pH 12 and 100° C. As a reference, Elmer's® household white glue had an adhesive strength of 1433 N. Except for the 120° C. treatment, adhesive strength increased with the increase of pH. Furthermore, at a given pH, as temperature increased from 80 to 100° C., adhesive strength improved with this improvement being more significant at pH 10 and 12. However, as the temperature increased further to 120° C., adhesive strength appeared to be somewhat compromised for all pH values.

In the presence of water, once the gelatinization temperature is reached starch fully develops its adhesive properties. Above this temperature an increase in adhesive strength may be due to the contribution of protein. Therefore, it is possible that the increase in adhesive strength above 80° C. may be due mainly to the contribution of protein. The contribution of starch to adhesion is important considering commercial bran in the US may contain up to 20% starch.

Protein contribution to RBA strength is likely to increase with pH and temperature by an initial increase in solubility and dispersion. The apparent decrease in adhesive strength at all pH levels as the temperature increased from 100 to 120° C. was not statistically significant at the 95% confidence level.

Statistical analysis determined pH had a significant effect on adhesive strength while temperature and pH-temperature interaction did not. Tukey's test showed that pH 10 treatment was not different from pH 8 or 12 treatments, however the latter treatments were significantly different from each other.

Adhesive Viscosity

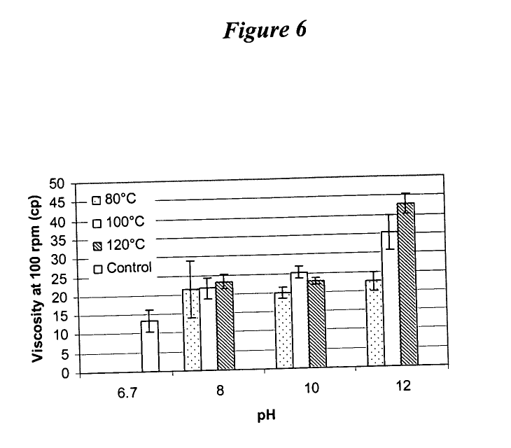

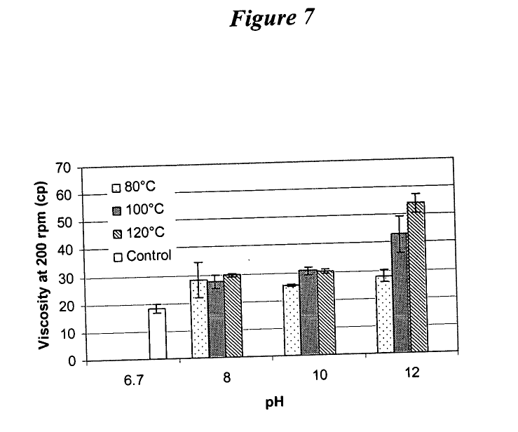

Viscosity is also an important adhesive characteristic. In general, low viscosity is desired to facilitate adhesive handling and application. The effect of pH and temperature on the viscosity of RBA measured at 100 and 200 rpm are shown in FIGS. 6 and 7, respectively. Compared to the control, RBA treated with heat and alkali had a greater viscosity. Viscosity measured at 100 rpm increased from 14 cp for the control to 43 cp for the sample treated at pH 12 and 120° C. Similarly, viscosity measured at 200 rpm increased from 19 to 54 cp. The increased viscosity of treated RBA compared to the control is likely a result of the combined effects of starch gelatinization and protein denaturation due to pH and temperature treatments. Viscosity was similar for all samples treated at pH 8 and 10. However, viscosity significantly increased at pH 12 when treatment temperature increased from 80 to 120° C. The slight initial increase in viscosity compared to the control sample may be largely due to starch gelatinization. However, at high pH values, the increase in viscosity may be largely due to protein unfolding. Despite the increase in viscosity of pH and temperature treated samples compared to the control, overall the viscosity remains acceptably low considering that the viscosity of the currently used synthetic adhesive PMDI is 200 cp at 25° C.

Statistical analysis showed that pH, temperature and pH-temperature interaction had a significant effect on RBA viscosity (at both 100 and 200 rpm). In terms of significant differences, for both viscometer speeds, the 100° C. treatment was not different from the 120 or the 80° C. treatments but the latter were different from each other. Similarly, the pH 12 treatment (also for both viscometer speeds) was different from both the pH 8 and 10 which in contrast, were not significantly different from each other.

Adhesive PH

PH of an adhesive is an important factor for determining if the adhesive is suitable to be used in multicomponent systems, such as particleboard, where pH may play an important role in defining the stability and characteristics of the final product. Though it is l obvious that RB adjusted to higher pH will result in a RBA with a higher pH compared to that adjusted to lower pH, it is important to determine how treatment and adhesive preparation affect the pH of RBA.

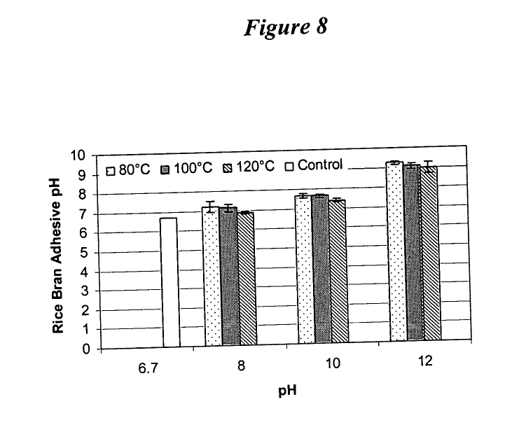

The pH to which RB was adjusted prior to drying was slightly higher than the pH of RBA (FIG. 8). This is probably due to the higher overall NaOH concentration of the former solution compared to the latter. The statistical analysis showed that pH and temperature had a significant effect on the pH of RBA at the 95% confidence level, while pH-temperature interaction did not. At a given pH, as temperature increased, the pH of the prepared RBA slightly decreased. It is possible that at a given pH, an increase in temperature may favor a chemical reaction that involves the consumption of Hydrogen ions which in turn results in a slightly lower pH. Tukey's test showed that the 100° C. treatment was not significantly different from the 80 or 120° C. treatments while the latter treatments were different from each other. As expected, pH 8, 10 and 12 treatments were all significantly different from each other with respect to the pH of the prepared RBA.

Effect of Sulfites on Rice Bran Adhesive

Table 3 shows the effect of sulfites on the properties of RBA treated at 100° C. and pH 12. Except for the sample treated with sodium sulfite (1M), adhesive yield was not radically affected by the presence of sulfites. The yield increase for all but one of the treatments compared to the control may be the result of a decrease in RBA cohesiveness due to disulfide bond cleavage which in turn may decrease the hardness of the oven dried rice bran product and increase yield.

Contrary to what was expected, addition of sulfites significantly reduced the strength of RBA. This effect was probably the result of excessive disulfide bond cleavage.

TABLE 3
Effect of sulfites on rice bran adhesive.

| | Sodium Sulfite | | Sodium Bisulfite | | |
|---|---|---|---|---|---|
| Property | 0.5M | 1M | 0.5M | 1M | Control* |
| Yield (%) | 44.9 | 54.0 | 48.0 | 38.6 | 43.8 |
| Strength (N) | 27.5 | 16.5 | 26.0 | 18.4 | 180.8 |
| μ 100 rpm (cps) | 57.5 | 35.8 | 34.2 | 40.0 | 35.2 |
| μ 200 rpm (cps) | 70.8 | 47.5 | 41.9 | 52.5 | 42.8 |
| pH | 9.09 | 9.3 | 6.3 | 6.0 | 9.1 |

*Control here refers to the sample modified at pH 12 and 100° C. but without sulfites addition

The effect of adding sulfites on the viscosity of RBA was somewhat unclear. The viscosity obtained for samples treated with sodium bisulfite or 1M sodium sulfite did not vary significantly from the sample treated at similar pH and temperature without sulfites. The higher viscosity compared to the control obtained for the sample containing sodium sulfite (0.5M) may be explained by a decrease in protein solubility due to disulfide bond breakage. The cleavage of disulfide bonds brings about structural changes that expose the non-polar groups previously buried inside the protein interior, thereby increasing the surface hydrophobicity. This probably decreases the surface polarity to hydrophobicity ratio, facilitating the protein-protein association and ultimately resulting in a lower solubility which in turn would increase viscosity.

The effect of sodium sulfite on the pH of RBA appears to be negligible compared to the effect of sodium bisulfite. Clearly, the pH of RBA treated with sodium bisulfite was significantly lower that the pH of the control and that of the samples treated with sodium sulfite. In the presence of water sodium bisulfite may form sodium hydroxide and sulfurous acid which may have contributed to lower the pH. Overall, it is difficult to explain the behavior of RBA as a whole based solely on the behavior of its individual components. Interactions among rice bran constituents surely play an important role in the overall behavior of the developed biobased adhesive.

Overall, high pH and temperature treatments proved to be effective in developing the adhesive properties of RB to obtain a RBA with improved adhesive strength compared to the untreated control. Sulfites, on the other hand, were detrimental to the strength of RBA. The developed RBA had a relatively low viscosity and may be potentially used as an adhesive for particleboard manufacturing.

### Example 2

Characteristics Of Particleboard Bound With PMDI And Rice Bran Adhesive

From the previous experiments, it was determined that pH 12 and 100° C. were the optimum conditions required to obtain a satisfactory RBA that may be used to bind particleboard. Therefore, these pH and temperature conditions were used to modify bran and obtain enough RBA for assessing its particleboard binding ability. For this purpose, different amounts of synthetic PMDI particleboard adhesive were replaced with RBA. The quality of the resulting particleboard product was then evaluated to determine the effect of RBA on the properties of the board.

5.1. Materials and Methods

### Materials

Rice straw, from Colusa, Calif., was from medium grain rice variety M202 and had average moisture content of 7%. Polymeric diphenyl methane diisocyanate (PMDI) was obtained from Bayer Polymers LLC (Pittsburgh, Pa.) and contained 100% solids. Defatted rice bran was obtained from RITO, Inc. (Stuttgart, Ariz.) and contained 3.77% fat, 16.57% protein and 11.28% ash according to manufacturer specifications.

Rice Straw and Rice Bran Adhesive Preparation

Rice straw size was reduced in a mill (Model C2690YB; Franklin Electric Co. Inc., Buffton, Ind.) using a 1.3 cm opening screen to control straw size. Rice bran adhesive (RBA) was obtained from rice bran treated at pH 12 and 100° C. as described above in the previous section of this report using. A 20% RBA solution was prepared and allowed to sit for 1 hour to achieve adequate adhesive hydration.

Manufacture of Particleboard

Medium density particleboard was fabricated according to the method proposed by Mo, X., E et al. Industrial Crops and products. 18:47-53 (2003). For the control, PMDI resin was added to the straw at 4% resin solid based on the weight of straw. With this PMDI content as a basis, 10, 20 and 30% PMDI was removed and replaced with 1, 5 or 20 g RBA solids per g PMDI removed (i.e. RBA solids added: PMDI removed replacement ratios of 1:1, 5:1 and 20:1). Therefore, a total of 10 adhesive systems were evaluated in terms of their ability to bind rice straw for particleboard production. The resulting adhesives were mixed with straw using a professional mixer (Model KP2671XBK; KitchenAid, Greenville, Ohio) for 15 minutes. The straw was then pre-pressed according to standard techniques.

The straw was then ready to press into particleboard using a hot press (Model 3891.4PR1A00; Carver Inc., Wabash, Ind.) equipped with 22.86×22.86 cm² metal plates. The mass of straw was adjusted so that the finished particleboard had a targeted final bulk density of 0.70 g/cm³ and thickness of 0.65 cm. Press conditions for the resonated straw were 1939 kPa at 140° C. for 8 minutes. The pressed particleboard was then trimmed to avoid edge effects, cut into various sizes for testing and finally conditioned for at least 48 hours in a Fisherbrand® Desiccator Cabinet maintained at a relative humidity of 65% by means of a saturated CoCl solution and a temperature of approximately 25° C.

Particleboard Evaluation

Mechanical Properties

Particleboards were cut into 3.8 cm×15.2 cm rectangular strips for determining tensile strength (TS), into 17.8 cm×5.1 cm for performing static bending tests, and into 5.1 cm×5.1 cm squares for internal bond (IB) strength measurements. Mechanical properties were determined according to the American Society of Testing and Materials. Standard Test Methods for Evaluating Properties of Wood-Base Fiber and Particle Panel Materials. Designation: D 1037-99. West Conshohocken, Pa. (1999) using an Instron testing machine (Model 1122; Instron Corporation, Canton, Mass.). The crosshead speeds were 4 mm/min for the tensile test and 5mm/min for the static bending and internal bond tests. Values for modulus of rupture (MOR) and modulus of elasticity (MOE) were obtained from the static bending test. Reported values are the averages of three replicates.

Water Absorption and Thickness Swelling

Water absorption and thickness swell properties were also determined according to the American Society of Testing and Materials. Standard Test Methods for Evaluating Properties of Wood-Base Fiber and Particle Panel Materials. Designation: D 1037-99. West Conshohocken, Pa. (1999). For this test, particleboard was cut into 15.2 cm×15.2 cm squares and soaked in water at room temperature for 24 hours. Board thickness and weight were measured before soaking and after 2 and 24 hours of water immersion to determine short and long term water absorption and thickness increase. Reported values are also the averages of three replicates.

Experimental Design and Data Analysis

To determine the effects of replacing different amounts of PMDI with RBA on the properties of rice straw particleboard, statistical analyses including ANOVA and Tukey's Studentized Range Tests (at 95% confidence level) were performed by means of SAS software (SAS Institute, Raleigh, N.C.). All boards were fabricated and tested in triplicates.

### Results and Discussion

Tensile Strength

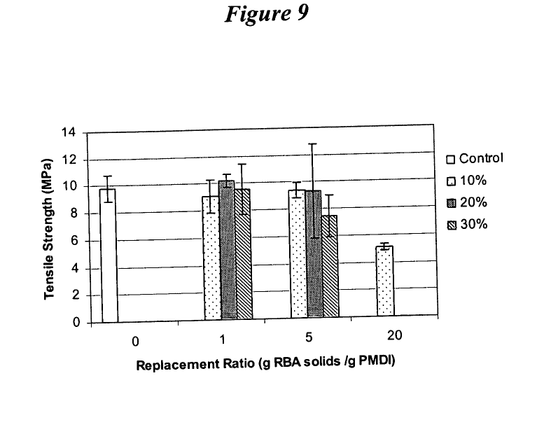

The results obtained from the TS tests are shown in FIG. 9. In general, as PMDI replacement with RBA increased, TS decreased. TS decreased from 9.8 MPa for the control (particleboard bound using 100% PMDI) to 5.1 MPa for the sample which contained RBA replacing 10% of PMDI (ratio 20:1). As the amount of RBA added to the straw increases, the amount of water present also increases. During hot pressing, this water turns to steam which abruptly expands when the press opens. While low amounts of steam may not significantly affect particleboard properties, larger amounts of steam may result in cohesively weak particleboard or may even cause the board to burst. For this reason, it was not possible to obtain particleboard samples for the 20 and 30% (ratio 20:1) PMDI replacement treatments.

Statistical analysis showed there was no significant difference in particleboard TS between the control and board manufactured with RBA replacing up to 30% of the synthetic adhesive (ratio 1:1). In fact, a 5:1 replacement ratio at the same 30% PMDI removal also resulted in PB with TS comparable to the control. But unless higher replacement ratios (i.e. 5:1 or 20:1) yield particleboard with improved properties, it is advantageous to use the minimum amount of RBA that will result in particleboard with properties comparable to the control. Contrary to what was expected, higher replacement ratios (i.e. 5:1 and 20:1) in general, did not prove beneficial. Initially, it was expected that more RBA solids added compared to the amount of PMDI removed would compensate for any expected decrease in strength of RBA compared to PMDI.

However, due to the fact that more RBA also means more water added to the straw, in most cases, a 1:1 replacement ratio proved sufficient to obtain a product with characteristics comparable to the control.

Static Bending: Modulus of Rupture and Modulus of Elasticity

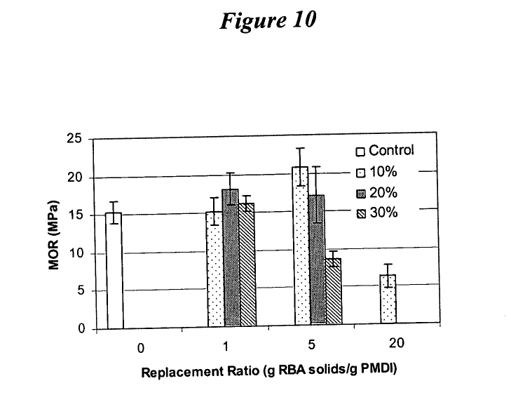

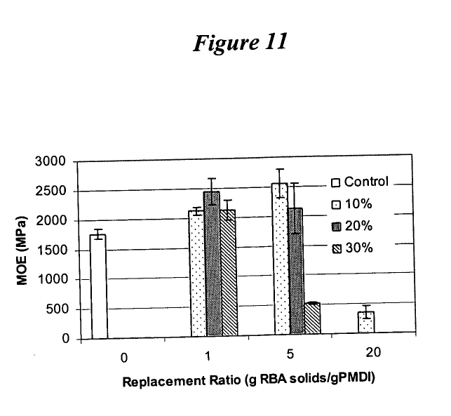

FIGS. 10 and 11 show the MOR and MOE results obtained from the static bending tests. The MOR measures the maximum bending load that a board can support. Its value indicates the stress required to cause failure. In general, at lower values of PMDI replacement with RBA particleboard samples were not significantly different from the control in terms of MOR. However, samples where RBA was added to the straw in larger quantities, had a significantly lower value of MOR compared to the control. Similar to the case of tensile strength, up to 30% PMDI replacement with RBA solids (ratio 1:1) resulted in particleboard with MOR characteristics comparable to the control (17 MPa compared to 16 MPa for the control).

The MOE, on the other hand, measures stiffness and indicates the ability to resist deflection. In general, MOE followed the same trend as MOR. MOE decreases at higher PMDI replacements with this decrease being more significant at higher replacement percentages and ratios. Again, a replacement of up to 30% PMDI with RBA resulted in particleboard with a MOE which was not statistically different than the control counterpart. It appears from the figure and from the statistical analysis, that a 20% PMDI replacement with RBA resulted in particleboard with improved MOE compared to the control (2800 MPa vs. 1750 MPa).

Internal Bond Strength

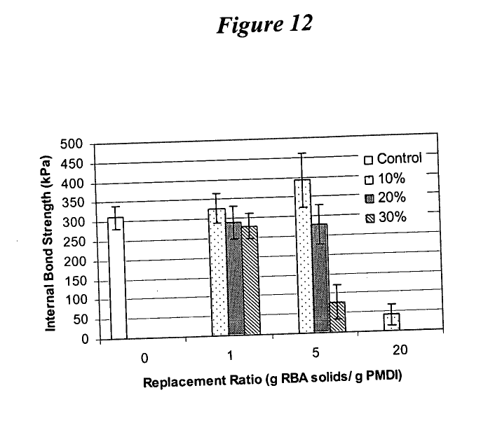

The IB strength results are shown in FIG. 12. The figure depicts the fact that in general, 113 strength decreased as the amount of PMDI replacement with RBA increased. This decrease in strength is more drastic at higher PMDI removal percentages and replacement ratios. For example, observe the trend for IB strength at a replacement ratio of 1:1 and 5:1. As the percentage of PMDI removal increases, IB strength decreases with this decrease being more pronounced for the later ratio compared to the former. Similar to the previous findings, statistical analysis suggested that a replacement of up to 30% PMDI with RBA (1:1 replacement ratio) results in a particleboard product with IB strength which is not significantly different from that of the control.

Water Absorption and Thickness Swell

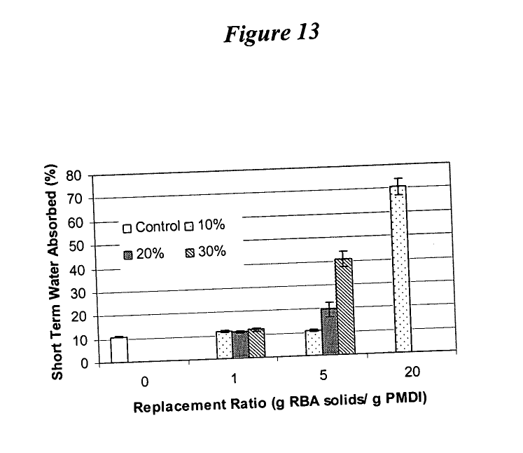

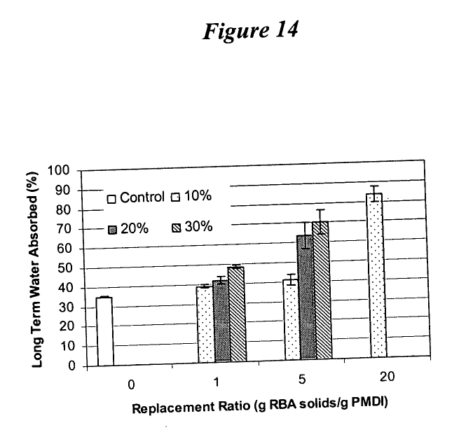

The results obtained for short term (2 hours) and long term (24 hour) water absorption are shown in FIGS. 13 and 14, respectively. The figures show that as the amount of RBA in particleboard increases, the amount of water absorbed by the board also increases. This result is expected considering not only the hygroscopic nature of the rice bran adhesive, but also the decreased cohesion obtained for particleboard bound with large amounts of RBA due to the additional water added to the straw as explained earlier. Low particleboard cohesion allows water to more easily penetrate through the poorly bonded board matrix. Again, statistical analysis showed that there are no statistically significant differences between the control and particleboard which had up to 30% PMDI replaced with RBA (1:1 replacement ratio) in terms of short term water absorption. However, only 20% PMDI may be removed and replaced with RBA solids at a ratio of 1:1 to obtain a particleboard product with long term water absorption properties comparable to the control.

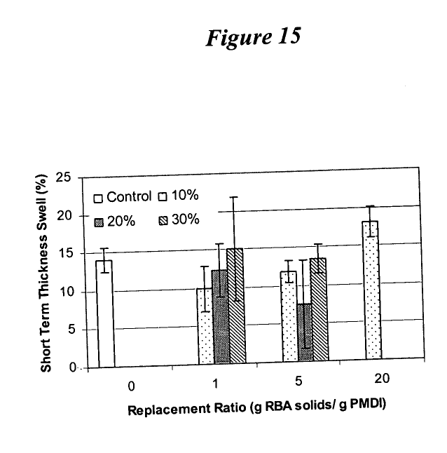

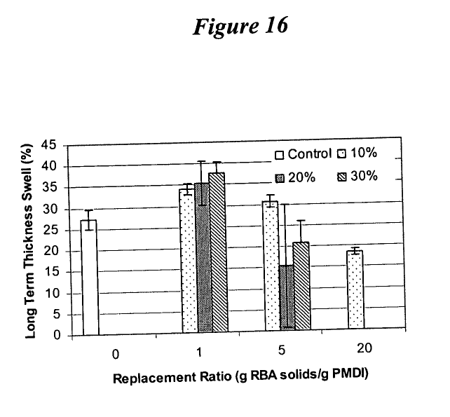

FIGS. 15 and 16 illustrate the results obtained for short term and long term particleboard thickness swell, respectively. Statistical analysis showed that there were no significant differences in terms of short and long term thickness swell between the control and particleboard which had up to 30% PMDI removed and replaced with RBA (1:1 replacement ratio). The figures show a slight increase in thickness swell for both short and long term as the percentage of PMDI replaced with RBA (1:1 replacement ratio) increased from 10 to 30%.

Comparing the figures depicting the results obtained for short term and long term thickness swell, there appears to be an important difference between the swelling rates of particleboard containing different amounts of RBA. After 2 hours of water immersion, the 10% PMDI removal sample (replacement ratio 1:1) had a thickness swell of only 9.92% while the sample with the same 10% PMDI removal but 20:1 replacement ratio had a value of 17%. Note that after 24 hours, the thickness swell value of the former sample increased to 34% while that for the latter remained almost the same at 18%.

Overall, the results obtained proved that RBA is suitable for use as an adhesive to replace a portion of the currently used synthetic adhesive PMDI for the production of particleboard. Up to 30% PMDI may be removed from particleboard and replaced with RBA to obtain a product with similar characteristics to those of board bound using PMDI only. This is true for all particleboard properties assessed in this report except long term water absorption. In this case, only 20% PMDI may be replaced with RBA to obtain particleboard with long term water absorption properties comparable to those of PMDI bonded board.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A method of preparing a cereal-based adhesive, the method comprising adjusting the pH of a cereal bran slurry to a pH of at least about 8 and heating the cereal bran slurry to at least about 80° C.

2. The method of claim 1, wherein the cereal bran slurry comprises about 20% solids.

3. The method of claim 1, wherein the cereal bran comprises particle sizes that pass through a US #100 mesh.

4. The method of claim 3, wherein the cereal bran slurry is in deionized water.

5. The method of claim 1, wherein the cereal bran is defatted.

6. The method of claim 1, wherein the cereal bran is rice bran.

7. The method of claim 1, wherein the pH of the cereal bran slurry is adjusted to a pH of about 8 to about 12.

8. The method of claim 7, wherein the pH of the cereal bran slurry is adjusted to a pH of about 12.

9. The method of claim 1, wherein the pH is adjusted using a IN NaOH solution.

10. The method of claim 1, further comprising drying the slurry to produce a dry powder.

11. The method of claim 10, further comprising grinding the dry powder to a desired particle size.

12. A cereal-based adhesive made by a method comprising adjusting the pH of a cereal bran slurry to a pH of at least about 8 and heating the cereal bran slurry to at least about 80° C.

13. The cereal-based adhesive of claim 12, wherein the cereal bran slurry comprises about 20% solids.

14. The cereal-based adhesive of claim 12, wherein the cereal bran is milled.

15. The cereal-based adhesive of claim 14, wherein the cereal bran slurry is in deionized water.

16. The cereal-based adhesive of claim 12, wherein the cereal bran is defatted.

17. The cereal-based adhesive of claim 12, wherein the cereal bran is rice bran.

18. The cereal-based adhesive of claim 12, wherein the pH of the cereal bran slurry is adjusted to a pH of about 8 to about 12.

19. The cereal-based adhesive of claim 18, wherein the pH of the cereal bran slurry is adjusted to a pH of about 12.

20. The cereal-based adhesive of claim 12, wherein the pH is adjusted using a IN NaOH solution.

21. A dry powder made by drying the cereal based adhesive of claim 12.

22. A method of joining two substrates together, the method comprising contacting the substrates with a cereal-based adhesive of claim 12.

23. The method of claim 22, wherein the substrates comprise lignocellulosic material.

24. The method of claim 23, wherein the substrates are particles used to make particle board.

25. A composite panel comprising the cereal-based adhesive of claim 12.

26. The composite panel of claim 25, which is particle board.

27. The composite panel of claim 25, which is fiber board.
